(19) United States
(12) Patent Application Publication
(10) Pub. No.: US 2016/0117755 A1
(43) Pub. Date: Apr. 28, 2016

(54) Replacement Upholstery System And Method For Electronically Identifying And Ordering Replacement Upholstery

(71) Applicant: John L. Vandenberg, Missoula, MT (US)

(72) Inventor: John L. Vandenberg, Missoula, MT (US)

(21) Appl. No.: 14/925,811

(22) Filed: Oct. 28, 2015

Related U.S. Application Data
(60) Provisional application No. 62/069,751, filed on Oct. 28, 2014.

(51) Int. Cl. G06Q 30/06; G06F 17/30; G06T 11/20; A47C 7/24; G06T 11/00

(52) U.S. Cl. CPC G06Q 30/0633; G06Q 30/0625; A47C 7/24; G06T 11/001; G06T 11/20; G06F 17/30268; G06F 17/30256

(57) ABSTRACT

The described “Replacement Upholstery System and Method For Identifying and Ordering Replacement Upholstery,” provides a unique and convenient process for replacing worn upholstery and software for ordering replacement upholstery, which is shipped directly to and installed by the end user. The process utilizes a hook and loop upholstery recovering system, which allows the end user to easily replace damaged or worn upholstery. Once the system is in place, the physical seating arrangement, and dimensions of the seating furniture are mapped digitally, and associated with the specified product for each piece of seating furniture. A system administrator then establishes an account for the end user, which can be accessed by software installed on any general use computer. The end user then clicks on the digitally represented piece of furniture to generate an order for a replacement cover. The replacement cover is then fabricated and shipped to the end user for installation. This system and method can be used in any setting where seating upholstery is utilized. The preferred embodiment has been developed for the restaurant industry for replacement of booth and chair upholstery.

### CROSS-REFERENCE TO RELATED APPLICATION

This application claims the benefit of Provisional Application No. 62/069,751 filed on Oct. 28, 2014.

### BACKGROUND OF THE INVENTION

1. Field of the Invention

The present disclosure relates to the field of seating upholstery. The system provides an easy and efficient way to replace worn upholstery, and then re-order custom upholstery covers based upon demand. The invention was developed for use in the restaurant industry where upholstered booths and chairs are subject to constant wear, and require replacement periodically. However, the system can be applied to any situation where the end user desires easy and efficient upholstery replacement.

2. Description of the Related Art

Upholstery recovering methods, and various ordering systems are described in the art. Upholstery recovering generally requires special skill from someone experienced in the field. As such, recovering upholstery will generally require the hiring of someone experienced in the field to come on-site, remove existing worn upholstery, take measurements for replacement upholstery, procure replacement upholstery material, cut replacement upholstery material, and install the replacement upholstery. The installation of replacement upholstery is generally accomplished by applying the replacement material, and stapling the replacement material to the underside of the chair or booth that is being recovered. The problem for end users and especially restaurant owners is that seating upholstery does not all wear at the same rate. Therefore, an upholstery service person must be called every time a chair or booth is in need of recovering. This requires multiple trips by the service person to the site, which can be both costly and time consuming. This method is also dependant on the service person's schedule, not the end user's demand. Similarly, when seating of different dimensions require replacement, multiple measurements, and procurement of replacement material will need to be performed by the service person. Again, this method is time consuming, costly, and potentially wasteful because measurements, which are constant, will likely be lost, or unavailable for any future demand for recovering.

The herein described system and method for re-ordering custom upholstery covers solves the problems that exist in this field.

### OBJECTS OF THE INVENTION

The object of the invention described herein is to solve the above described problems in the field by providing an upholstery recovering system that allows the customer to order and install a replacement cover with ease and minimal training. The system achieves this by removing the worn upholstery in need of replacement. A hook and loop fastening system is then utilized by installing the hook portion to the substrate of the seating furniture. The loop portion of the fastening system is then applied to the recovering material, which has been pre-measured and cut to the precise dimensions of the seating furniture. The new upholstery cover is then easily attached to the seating furniture by simply stretching the cover over the portion to be recovered, and engaging the hook and loop system to fasten the cover in place. The system can be installed on any pre-existing seating furniture, or can be pre-installed in factory on any new seating furniture.

Once the system has been subscribed to by the end user, re-ordering of future replacement covers is accomplished through unique computer software, which is integral to the system. A location specific floor plan of all upholstered furniture is provided by the end user generally in the form of a hand written floor plan map, or photograph. Precise measurements are provided for each piece of upholstered furniture. This data is then utilized to produce a digital map of the facility's upholstered furniture. Each piece of seating furniture represented on the digital map is individually numbered and assigned product information specific to that piece of furniture. Product information includes measurements, color, and pattern information to generate the specific replacement cover for that piece of furniture. The end user simply selects the digital representation for the piece of furniture in need of recovering, which automatically generates an order for the replacement cover, specific to that piece of furniture. The replacement cover is then fabricated on demand, and shipped directly to the end user. The end user can then install the replacement cover without the need for hiring an upholstery service person.

### SUMMARY OF THE INVENTION

The invention consists of a unique system of replacing worn upholstery and a convenient method to easily order replacement upholstery, which can be installed by the end-user with ease, and minimal training. This system can be utilized in any setting where upholstery is subject to wear and periodic replacement. Such settings include restaurants, hotels, schools, public buildings, automobiles, heavy equipment, office furniture, hospitals, etc.

The described upholstery recovering system is utilized to recover worn upholstery in need of replacement. FIG. 1. The worn upholstery is removed from the existing seating furniture by detaching the existing fastening means, usually staples, and removing the old seat cover. FIG. 2. All existing attachment means are removed to provide a clean substrate surface to install the new system upon. FIG. 2. The “hook” portion of the hook and loop fastening system is then installed on the existing seating substrate, which will accept the “loop” portion of the system, which has been pre-stitched onto the replacement seat cover. FIG. 3. The replacement cover is then installed by simply fitting the precisely pre-measured and cut replacement cover over the seating furniture, and fastening the pre-stitched “loop” portion to the installed “hook” portion to achieve secure fastening, and precise fit. FIG. 3. Once installed, the replacement cover will make the seating furniture appear brand-new. FIG. 7. The system can be installed on any pre-existing seating furniture, or can be pre-installed in factory on any new seating furniture. Once the “hook” portion of the system is installed, any end user can install replacement covers with minimal training, and without requiring the services of an upholstery service person.

A unique feature of the system is the convenient method of ordering replacement upholstery covers for installation directly by the end user. When the system is subscribed to by the end user, the end user, or administrator provides a location specific floor plan of all upholstered furniture, generally in the form of a hand written floor plan map, or photograph. FIG. 4. The provided floor plan data is then utilized to produce a digital map of the facility's upholstered furniture. FIG. 5. Precise measurements for each digitally represented piece of furniture are acquired by the end user, or administrator, and are provided to the administrator. Each piece of seating furniture represented on the digital map is individually numbered and assigned product information specific to that piece of furniture, including the measurements, color, and pattern information to generate the specifications for the replacement cover for that piece of furniture. FIG. 6.

The transformation of the raw measurement, color, and pattern information into the specified replacement cover to be shipped to the end user is accomplished by software utilized on any general purpose computer. The steps required by the Administrator to create the digital floor map function are comprised of:
1) The administrator chooses to use the feature for a client, by selecting an upload control.
2) The Administrator selects the image file from the local computer. After the file is uploaded to a server and saved in a temporary location, the administrator clicks on a “Save” button.
3) When the “Save” button is clicked, the system generates a unique file name and saves the image file to the database.
4) The Administrator then goes into the management area to create the image maps. FIG. 5.
5) Upon entering the management area, the image file is displayed along with an HTML dropdown control containing the products with the specified measurements, color, and pattern information that are associated to the location of the specific piece of furniture. The Administrator then clicks on the image in location of the specific piece of furniture to create a circle ‘hotspot’ by returning the X and Y values along with the radius of the circle to create an HTML hotspot. That data along with the specified product data are saved to the database. This step is repeated until all pieces of furniture on the image map have been selected.

Each end user is assigned a specific user name and password specific to their facility, and account. The end user can log into their account to view their past order history, and conveniently order the product specified for each piece of digitally mapped furniture.

The steps required by the end user to complete the ordering process are comprised of:
1) The end user enters the system to order product by logging in with username and password. The image map, FIG. 6, is displayed to the end user as an HTML Image Map. Hotspots are loaded from the database to complete the requirements for the Image Map control to function properly.
2) The end user then clicks on the specific piece of seating or furniture on the image map, FIG. 6 to indicate which piece of seating or furniture is in need of a replacement cover. The system then looks up the specific product information that has been pre-associated with the hotspot and adds quantity 1 to the shopping cart. If the hotspot has been previously selected, the quantity is incremented by 1 in the shopping cart.
3) When finished, user clicks on checkout. Product totals are calculated and saved to the database as an order.
4) Order details are displayed on screen, as well as in an email that is automatically generated and sent to the end user.
   Once the order is received by the Administrator, the specified product is fabricated to the pre-determined specifications associated to the piece of furniture selected by the end user. The product is then shipped to the end user for installation on the previously installed hook and loop fastening system to yield furniture with brand new upholstery. FIG. 7.

### BRIEF DESCRIPTION OF DRAWINGS

FIG. 1—Bench seat with worn upholstery cover in need of replacement.

FIG. 2—Underside of bench seat, removing old upholstery cover by removing staples and exposing clean furniture substrate.

FIG. 3—Underside of bench seat. Application of “hook” portion of new fastening system to the existing substrate, and installation of “loop” portion of new upholstery replacement cover.

FIG. 4—Handwritten map of facility seating furniture arrangement provided by end user, or Administrator.

FIG. 5—Administrator uploads handwritten map to create digital map of facility seating furniture with specific measurement, color, and pattern information associated to each specific piece of seating furniture.

End user selects piece of seating furniture to generate order for the associated product.

FIG. 6—End user selects piece of seating furniture in need of replacement on digital map by clicking on digital representation to generate order for the pre-associated product.

FIG. 7—Replacement upholstery cover after ordering and installation.

FIG. 8—Flowchart of process steps.

### DETAILED DESCRIPTION OF THE PREFERRED EMBODIMENTS

As noted above, the described system can be utilized in any setting where upholstery is subject to wear, and requires periodic replacement. The preferred embodiment of the system is herein described for use in the restaurant industry.

Many restaurants utilize booths and chairs with upholstery comprised of various materials. Restaurant upholstery is subject to constant wear and tear, and must be replaced on a regular basis. Worn upholstery is unsightly and can negatively affect the restaurant's quality of experience provided to customers. Upholstery wears at unpredictable rates. Therefore, replacing upholstery can be expensive and inconvenient to the restaurant owner. The described system was designed to provide an efficient, cost effective means for the restaurant owner to replace worn upholstery quickly, and without the services of an upholstery service person.

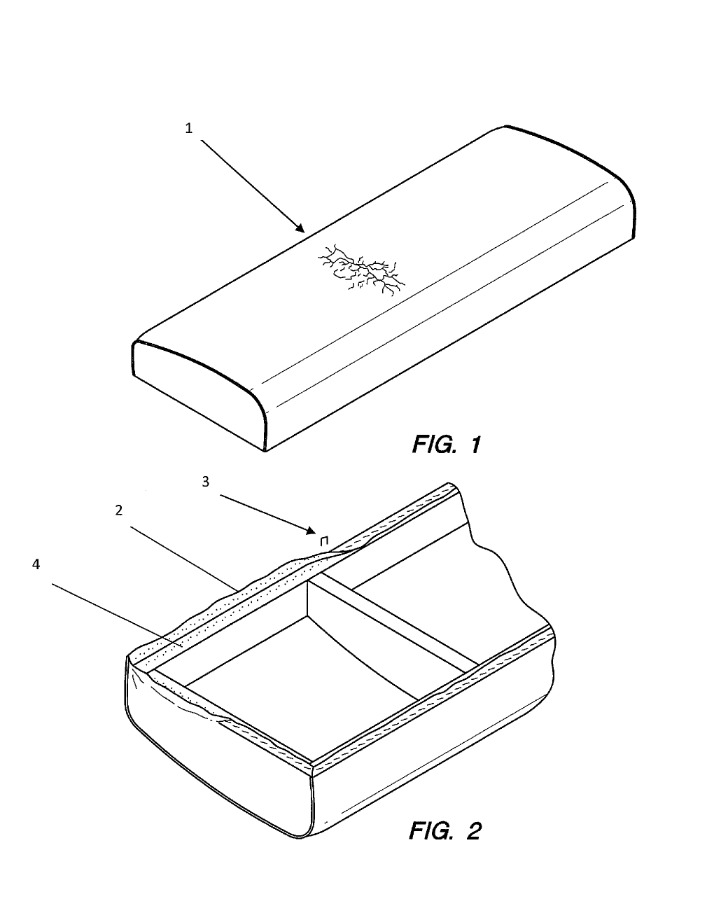

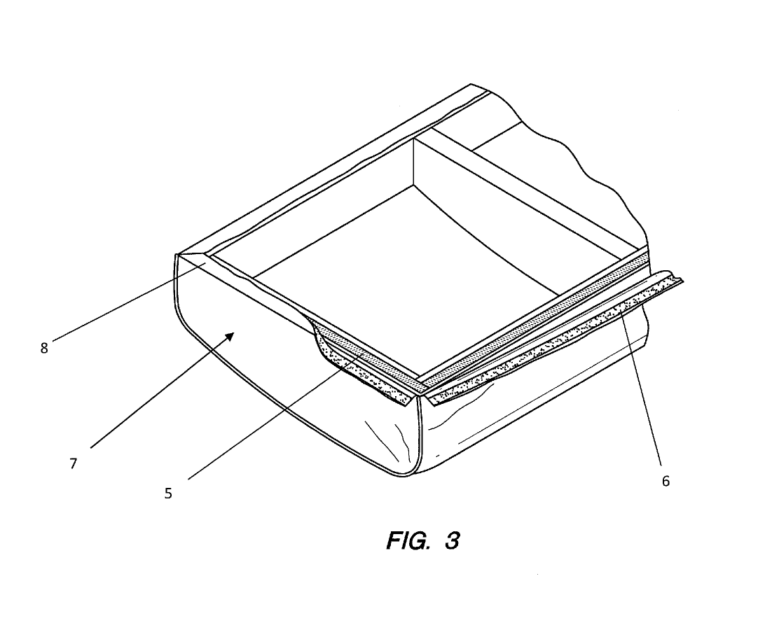

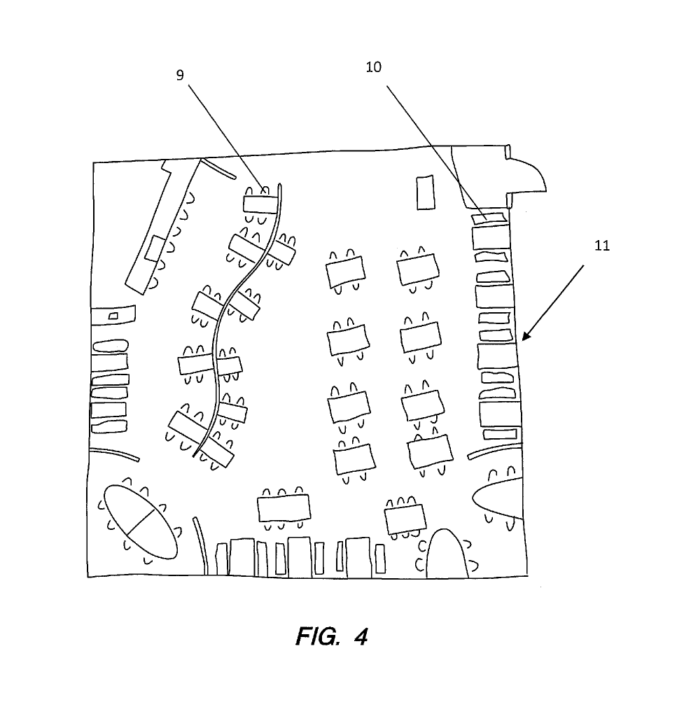

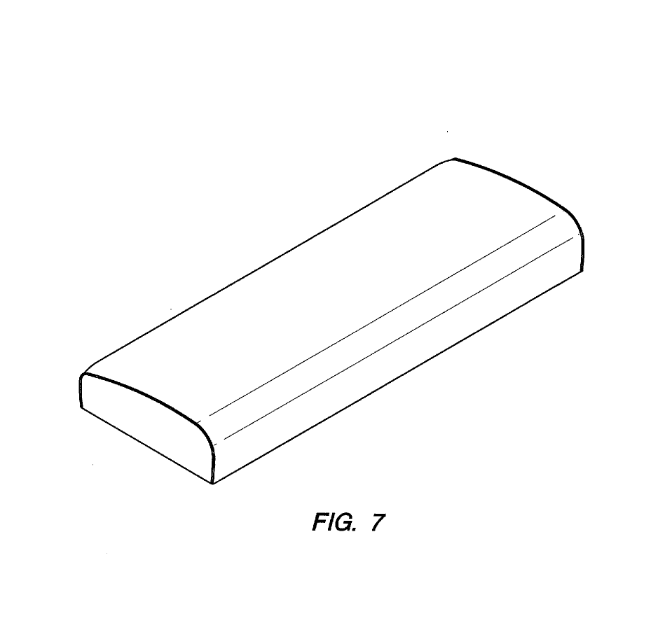

When restaurant seating upholstery is in need of replacement as shown in FIG. 1, the worn upholstery seat cover 1 is removed from the existing seating furniture 2 by detaching the existing fastening means, usually staples 3, and removing the old seat cover 1. All existing attachment means are removed to provide a clean substrate surface 4 to install the new system upon. The “hook” portion of the hook and loop fastening system 5 is then installed on the existing seating substrate 4, which will accept the “loop” portion of the system which has been pre-stitched onto the replacement seat cover 6. The replacement cover 7 is then installed by simply fitting the precisely pre-measured and cut replacement cover over the seating furniture, and fastening the pre-stitched “loop” portion 6 to the installed “hook” portion 5 to achieve secure fastening, and precise fit 8. Once installed, the replacement cover will make the seating furniture appear brand-new as shown in FIG. 7. The system can be installed on any pre-existing seating furniture, or can be pre-installed in factory on any new seating furniture. Once the “hook” portion of the system is installed 5, any end user, or restaurant personnel can install replacement covers 7 with minimal training, and without requiring the services of an upholstery service person.

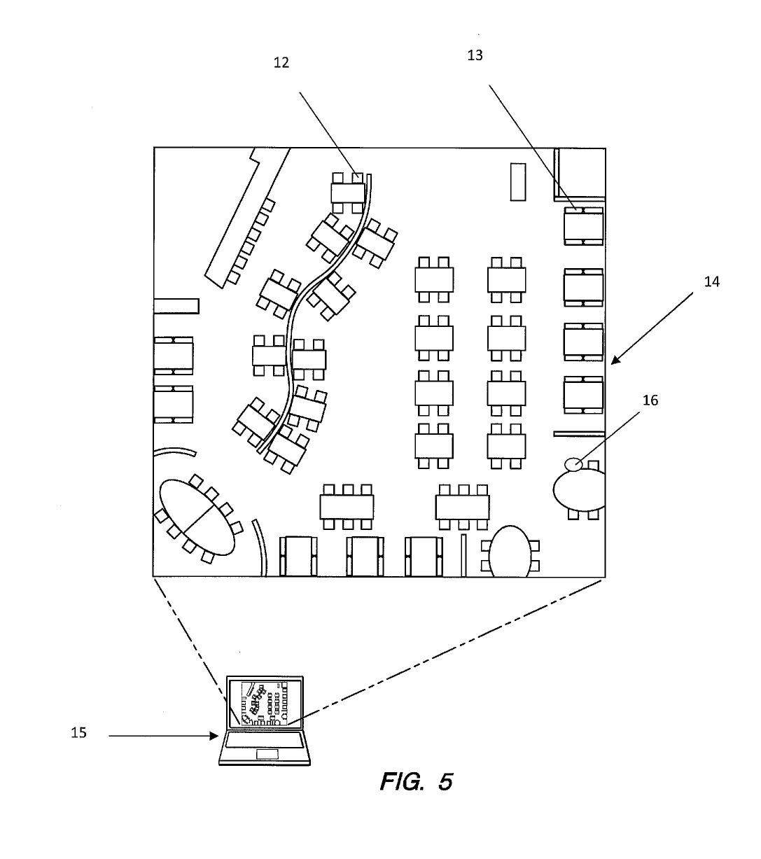

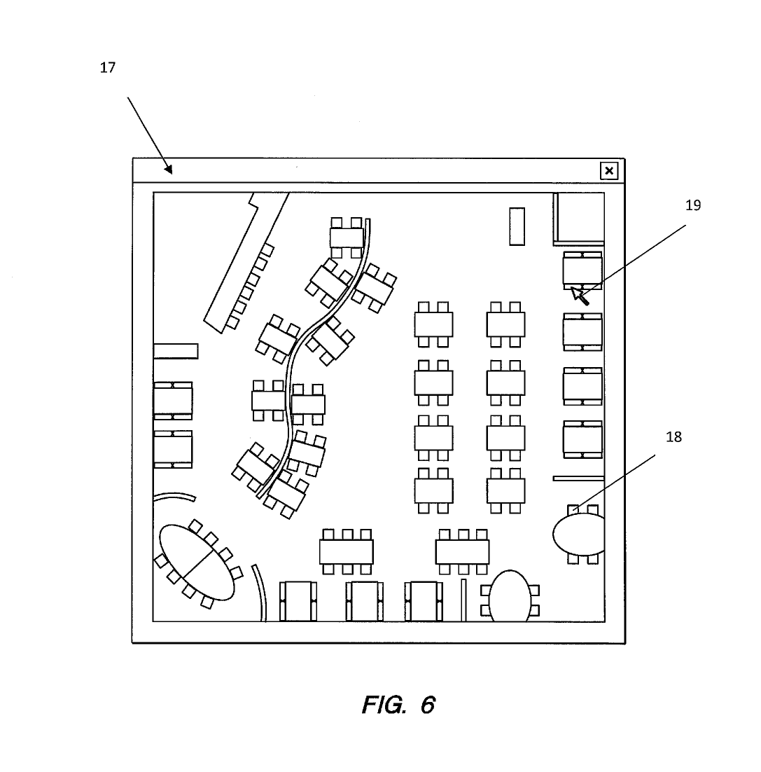

A unique feature of the system is the convenient method of ordering replacement upholstery covers for installation directly by the end user or restaurant personnel. When the system is subscribed to by a restaurant, the restaurant personnel, or administrator provides a location specific floor plan of all upholstered restaurant seating furniture (example of chair 9, booth bench 10), generally in the form of a hand written floor plan map 11, or photograph. The provided floor plan data is then utilized to produce a digital map of the restaurant's upholstered furniture as shown in FIG. 5. Precise measurements, color, and pattern information of preferred replacement covers 7 for each piece of furniture (examples 9, 10) are acquired by the restaurant personnel, or administrator, and are provided to the administrator to associate with each digital representation (example of chair 12, booth bench 13) of the restaurant's furniture. Each piece of seating furniture (example 12, 13) represented on the digital map, 14, is individually numbered and assigned product information specific to that piece of furniture, including the measurements, color, and pattern information to generate the specifications for the replacement cover for that piece of furniture 7.

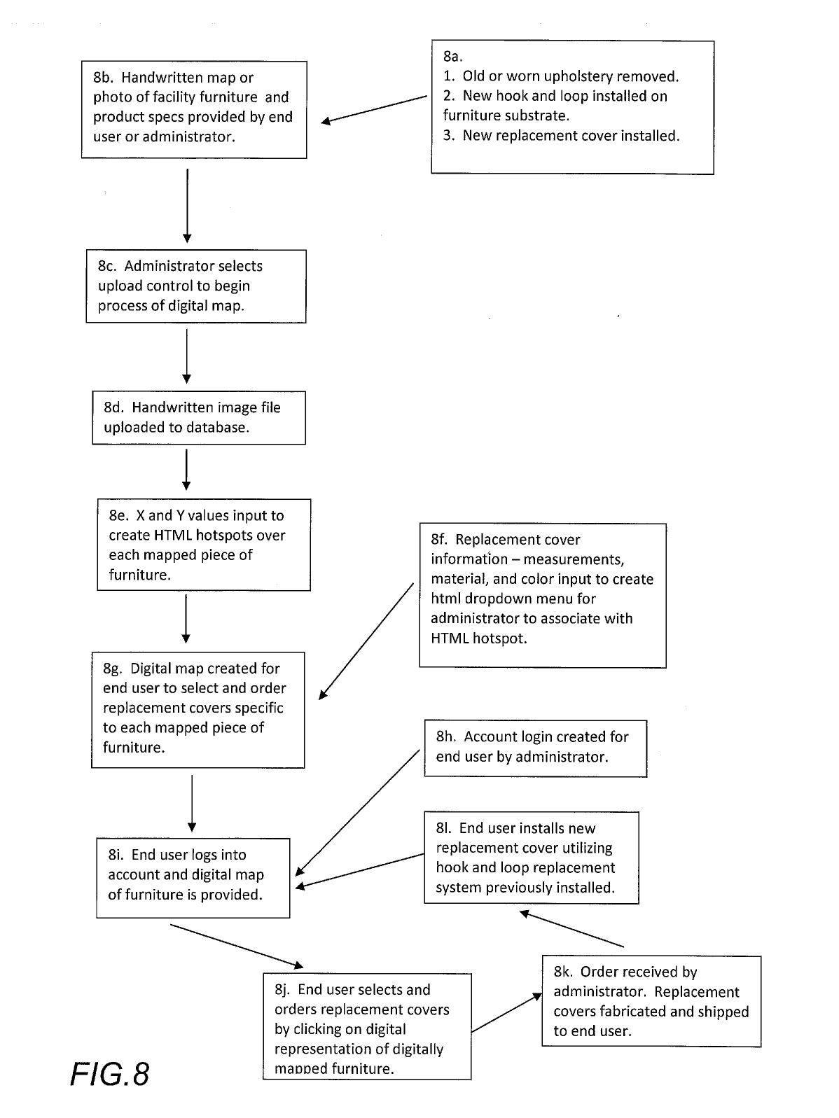

The transformation of the raw measurement, color, and pattern information 8b into the specified replacement cover 7 to be shipped to the restaurant for replacement is accomplished by software utilized on any general purpose computer 15. The steps required by the Administrator to create the digital floor map 14 function are depicted in FIG. 8, and are comprised of:
1) The administrator chooses to use the feature for a client, by selecting an upload control 8c to upload the image file 11, 8d.
2) The Administrator selects the image file 11 from the local computer 15. After the file is uploaded to a server and saved in a temporary location, the administrator clicks on a “Save” button.
3) When the “Save” button is clicked, the system generates a unique file name and saves the image file to the database.
4) The Administrator then goes into the management area to create the image maps.
5) Upon entering the management area, the image file is displayed along with an HTML dropdown control containing the products with the specified measurements, color, and pattern information that are associated to the location of the specific piece of furniture 8f. The Administrator then clicks on the image in location of the specific piece of furniture to create a circle ‘hotspot’ by returning the X and Y values along with the radius of the circle to create an HTML hotspot 16. That data along with the specified product data 8f are saved to the database. This step is repeated until all pieces of furniture on the image map 14 have been selected 8g.

Each restaurant is assigned a specific user name and password specific to their facility, and account 8h. The restaurant personnel can log into their account to view their past order history, and conveniently order the product specified for each piece of digitally mapped furniture 8i. The steps required by the restaurant personnel to complete the ordering process are comprised of:
1) The restaurant personnel enters the system to order product by logging in with username and password 8i. The image map 17, is displayed to the restaurant personnel as an HTML Image Map. Hotspots 16 are loaded from the database to complete the requirements for the Image Map control to function properly 18.
2) The restaurant personnel then clicks on the specific piece of furniture 19 on the image map, 17, to indicate the piece of furniture that requires a replacement cover 7, 8j. The system then looks up the specific product information that has been pre-associated with the hotspot and adds quantity 1 to the shopping cart. If the hotspot has been previously selected, the quantity is incremented by 1 in the shopping cart.
3) When finished, the restaurant personnel clicks on checkout. Product totals are calculated and saved to the database as an order.
4) Order details are displayed on screen, as well as in an email that is automatically generated and sent to the restaurant. The order is then received by the Administrator 8k.

Once the order is received by the Administrator 8k, the specified product 7 is fabricated to the pre-determined specifications 8f associated to the piece of furniture selected by the restaurant 19, 8k. The product 7 is then shipped 8k to the restaurant for installation on the previously installed hook 5 and loop 6 fastening system 8l. Once installed, the selected seating upholstery will appear brand new as shown in FIG. 7.

Once the system is installed and subscribed to, the restaurant personnel can log into the restaurant's account and easily order upholstery replacement covers when upholstery on individual pieces of furniture begin to show wear by logging into their account 8i, selecting the digital representation of the individual piece of furniture in need of upholstery replacement 8j, and installing the new upholstery cover when it arrives 8l.

I claim:

1. A Replacement Upholstery System comprising:
(a) removal of worn upholstery from existing furniture;
(b) detaching all existing fastening means from said furniture to provide a clean substrate;
(c) installing hook portion of fastening system to said substrate by any fastening means;
(d) obtaining measurements of said furniture for replacement upholstery cover;
(e) fabricating said replacement upholstery cover including pre-stitched loop portion of fastening system;
(f) applying said loop portion of said replacement upholstery cover to said hook portion of fastening system to recover said existing furniture.

2. The Replacement Upholstery System of claim 1 where said system is specific to restaurant furniture.

3. The Replacement Upholstery System of claim 1 where said system is specific to restaurant booths.

4. The Replacement Upholstery System of claim 1 where said system is specific to restaurant chairs.

5. A Method For Electronically Identifying Replacement Upholstery comprising:
(a) obtaining the subscribing facility's floor plan of existing upholstered furniture by any recording means;
(b) providing measurements, color, and pattern information for each piece of said upholstered furniture;
(c) selecting an upload control on a computer to upload said floor plan as an image file;
(d) saving said image file to software system database with unique file name;
(e) accessing management function of said software system via said computer to create digital image map of said floor plan;
(f) loading said digital image file;
(g) creating HTML image map by clicking on image of specific piece of furniture, inputting X and Y values for said specific piece of furniture; associating said measurements, color, and pattern information with said specific piece of furniture; and saving said X and Y values, measurements, color and pattern information to said software system database;
(h) create HTML hotspot for all individual pieces of furniture to complete said HTML image map;

6. The Method For Electronically Identifying Replacement Upholstery of claim 5 where said method is specific to restaurant furniture.

7. The Method For Electronically Identifying Replacement Upholstery of claim 5 where said method is specific to restaurant booths.

8. The Method For Electronically Identifying Replacement Upholstery of claim 5 where said method is specific to restaurant chairs.

9. A Method For Electronically Ordering Replacement Upholstery comprising:
(a) creating an account with username and password specific to subscribing facility to access software system;
(b) end user of said subscribing facility logs into said account to access said software system;
(c) An HTML image map of said subscribing facility's furniture is displayed;
(d) said end user clicks on piece of furniture represented on said HTML image map to generate an order for a replacement cover for said piece of furniture.

10. The Method For Electronically Ordering Replacement Upholstery of claim 9 where said method is specific to restaurant furniture.

11. The Method For Electronically Ordering Replacement Upholstery of claim 9 where said method is specific to restaurant booths.

12. The Method For Electronically Ordering Replacement Upholstery of claim 9 where said method is specific to restaurant chairs.

13. A Method For Electronically Identifying and Ordering Replacement Upholstery comprising:
(a) obtaining the subscribing facility's floor plan of existing upholstered furniture by any recording means;
(b) providing measurements, color, and pattern information for each piece of said upholstered furniture;
(c) selecting an upload control on a computer to upload said floor plan as an image file;
(d) saving said image file to software system database with a unique file name;
(e) accessing management function of said software system via said computer to create digital image map of said floor plan;
(f) loading said digital image file;
(g) creating HTML image map by clicking on image of specific piece of furniture, inputting X and Y values for said specific piece of furniture; associating said measurements, color, and pattern information with said specific piece of furniture; and saving said X and Y values, measurements, color and pattern information to said software system database;
(h) create HTML hotspot for all individual pieces of furniture to complete said HTML image map;
(i) creating an account with username and password specific to the subscribing facility to access said software system;
(j) end user of said subscribing facility logs into said account to access said software system;
(k) said HTML image map is displayed;
(l) said end user clicks on piece of furniture represented on said HTML image map to generate order for said replacement cover of said piece of furniture.

14. The Method For Electronically Ordering Replacement Upholstery of claim 13 where said method is specific to restaurant furniture.

15. The Method For Electronically Ordering Replacement Upholstery of claim 13 where said method is specific to restaurant booths.

16. The Method For Electronically Ordering Replacement Upholstery of claim 13 where said method is specific to restaurant chairs.

17. A Replacement Upholstery System and Method For Electronically Identifying and Ordering Replacement Upholstery comprising:
(a) removal of worn upholstery from existing furniture;
(b) detaching all existing fastening means from said furniture to provide a clean substrate;
(c) installing hook portion of fastening system to said substrate;
(d) obtaining measurements of said furniture for replacement upholstery cover;
(e) fabricating said replacement upholstery cover including pre-stitched loop portion of fastening system;
(f) applying said loop portion of said replacement upholstery cover to said hook portion of fastening system.
(g) obtaining subscribing facility floor plan of existing upholstered furniture by any recording means;
(b) providing measurements, color, and pattern information for each piece of said upholstered furniture;
(h) selecting an upload control on a computer to upload said floor plan as an image file;
(i) saving said image file to software system database with unique file name;
(j) accessing management function of said software system via said computer to create digital image map of said floor plan;
(k) loading said digital image file;
(l) creating HTML image map by clicking on image of specific piece of furniture, inputting X and Y values for said specific piece of furniture; associating said measurements, color, and pattern information with said specific piece of furniture; and saving said X and Y values, measurements, color and pattern information to said software system database;
(m) create HTML hotspot for all individual pieces of furniture to complete said HTML image map;
(n) creating an account with username and password specific to subscribing facility to access said software system;
(o) end user of said subscribing facility logs into said account to access said software system;
(p) said HTML image map is displayed;
(q) said end user clicks on piece of furniture represented on said HTML image map to generate order for said replacement cover of said piece of furniture.

18. The Replacement Upholstery System and Method For Electronically Identifying and Ordering Replacement Upholstery of claim 17 where said system and method is specific to restaurant furniture.

19. The Replacement Upholstery System and Method For Electronically Identifying and Ordering Replacement Upholstery of claim 17 where said system and method is specific to restaurant booths.

20. The Replacement Upholstery System and Method For Electronically Identifying and Ordering Replacement Upholstery of claim 17 where said system and method is specific to restaurant chairs.

21. The Replacement Upholstery System and Method For Electronically Identifying and Ordering Replacement Upholstery of claim 17 further comprising:
(a) said order being received by an administrator;
(b) said ordered replacement covers are fabricated by said administrator;
(c) said fabricated replacement covers are shipped to said end-user; and
(d) where said end user installs said replacement covers upon receipt.

22. The Replacement Upholstery System and Method For Electronically Identifying and Ordering Replacement Upholstery of claim 21 where said system and method is specific to restaurant furniture.

23. The Replacement Upholstery System and Method For Electronically Identifying and Ordering Replacement Upholstery of claim 21 where said system and method is specific to restaurant booths.

24. The Replacement Upholstery System and Method For Electronically Identifying and Ordering Replacement Upholstery of claim 21 where said system and method is specific to restaurant chairs.
